(19) United States
(12) Patent Application Publication
(10) Pub. No.: US 2019/0098866 A1
(43) Pub. Date: Apr. 4, 2019

(54) PET FOUNTAIN

(71) Applicant: Doskocil Manufacturing Company, Inc., Arlington, TX (US)

(72) Inventor: Ryan PAXSON, Box Elder, SD (US)

(21) Appl. No.: 16/150,987

(22) Filed: Oct. 3, 2018

Related U.S. Application Data
(60) Provisional application No. 62/567,483, filed on Oct. 3, 2017.

(51) Int. Cl. A01K 7/02; F04B 23/02

(52) U.S. Cl. CPC A01K 7/02; F04B 23/021

(57) ABSTRACT

A pet fountain includes a basin, a cover arrangement and a pump. The cover arrangement is disposed over the basin, and includes an upper bowl, a lower bowl and an inclined portion connecting the upper bowl and the lower bowl. The upper bowl includes openings disposed to enable water to fall from the upper bowl into the lower basin, and enables water to flow from the upper bowl along the inclined portion to the lower bowl. The pump is disposed in the basin and configured to pump water from the basin to the upper bowl.

### CROSS-REFERENCE TO RELATED APPLICATION

This application claims benefit of U.S. Provisional Application No. 62/567,483, filed Oct. 3, 2017, the contents of which are hereby incorporated herein by reference.

### BACKGROUND

### Field of the Invention

The present invention relates to a pet fountain including an arrangement for mounting a fountain cover system to a lower basin. More particularly, the present invention relates to using a pet fountain including an arrangement for mounting a fountain cover system to a lower basin with a pump to pump water from the lower basin to the fountain cover arrangement.

### Background of the Invention

There are many types of pet watering devices, including pet fountains, where an electrically powered pump is used to move water in a manner that is enticing to a pet while also helping to keep the water fresh. The pump is used to draw water from one part of the watering device and deliver it to another part of the watering device where it can flow back enabling the water to recirculate. Each watering device is configured in a manner that provides access to the water enabling a pet to drink water.

### SUMMARY

It has been discovered that improved pet fountains are desired. More aesthetically pleasing pet fountains are desired. In view of the state of the known technology, one aspect of the present disclosure is to provide a pet fountain, comprising a basin, a cover arrangement and a pump. The cover arrangement is disposed over the basin, and includes an upper bowl, a lower bowl and an inclined portion connecting the upper bowl and the lower bowl. The upper bowl includes openings disposed to enable water to fall from the upper bowl into the lower basin, and enables water to flow from the upper bowl along the inclined portion to the lower bowl. The pump is disposed in the basin and configured to pump water from the basin to the upper bowl. The pet fountain can include different designs to incorporate into the different components of the pet fountain.

### BRIEF DESCRIPTION OF THE DRAWINGS

The invention will be explained in more detail hereinafter with reference to the drawings.

FIG. 1 is a top perspective view of a pet fountain according to an embodiment of the present invention;

FIG. 2 is a partial cross sectional view of the upper basin disposed on the lower basin;

FIG. 3 is cross section view of the pet fountain of FIG. 1 with water disposed in the upper and lower bowls and the basin;

FIG. 4 is a partial top view of the basin;

FIG. 5 is a partial cross sectional view of the pump connected to the upper bowl and disposed in the basin;

FIG. 6 is a filter disposed in the basin;

FIG. 7 is a partial side view illustrating the power cord for the pump;

FIG. 8 is a partial top view of the basin illustrating an opening for the power cord of the pump; and

FIG. 9 illustrates one embodiment of the present invention.

FIG. 10 illustrates one embodiment of the present invention.

FIG. 11 illustrates one embodiment of the present invention.

FIG. 12 is a front perspective view of one embodiment of the present invention.

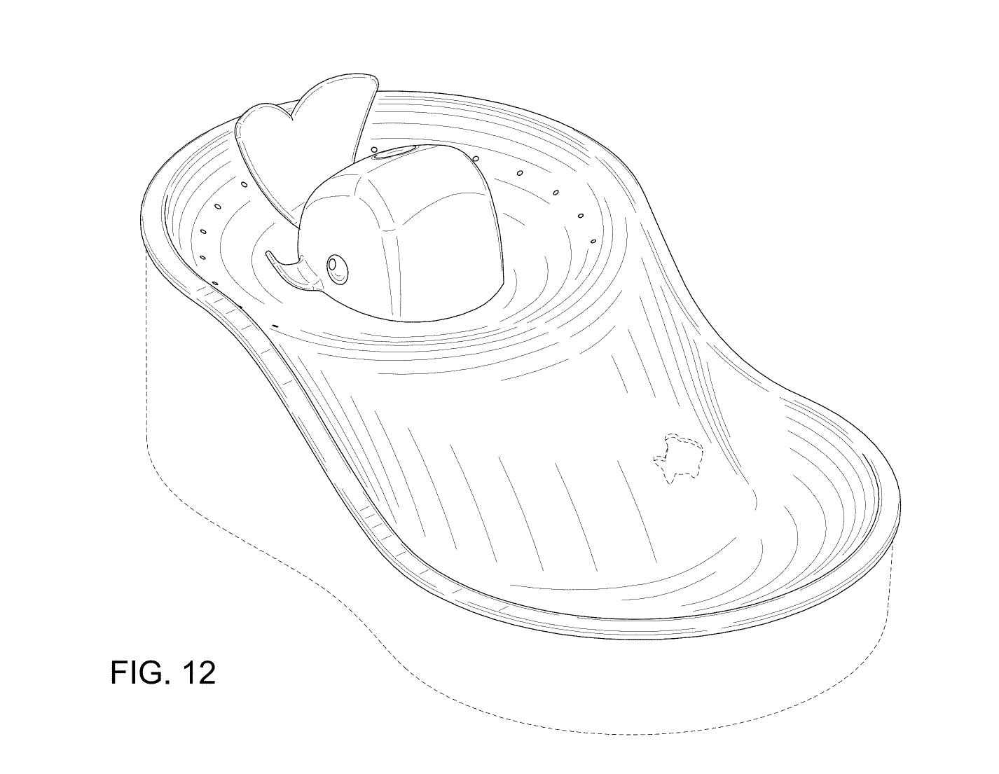

FIG. 13 is a front view of one embodiment of the present invention.

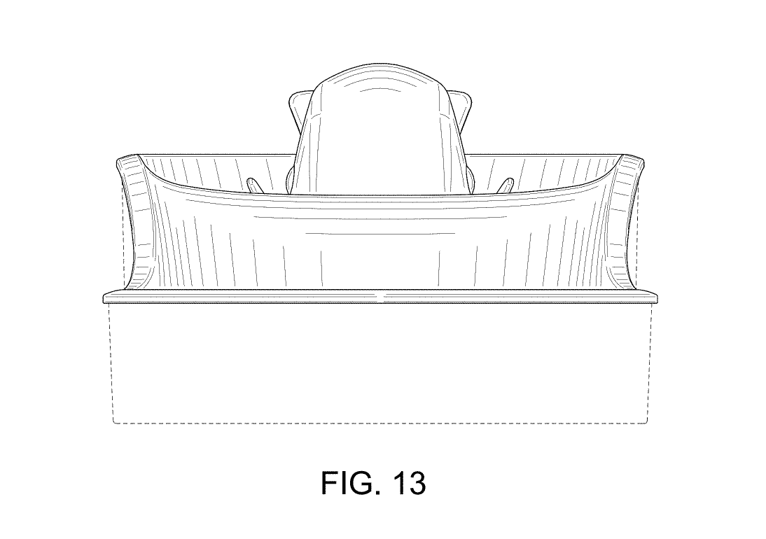

FIG. 14 is a back view of one embodiment of the present invention.

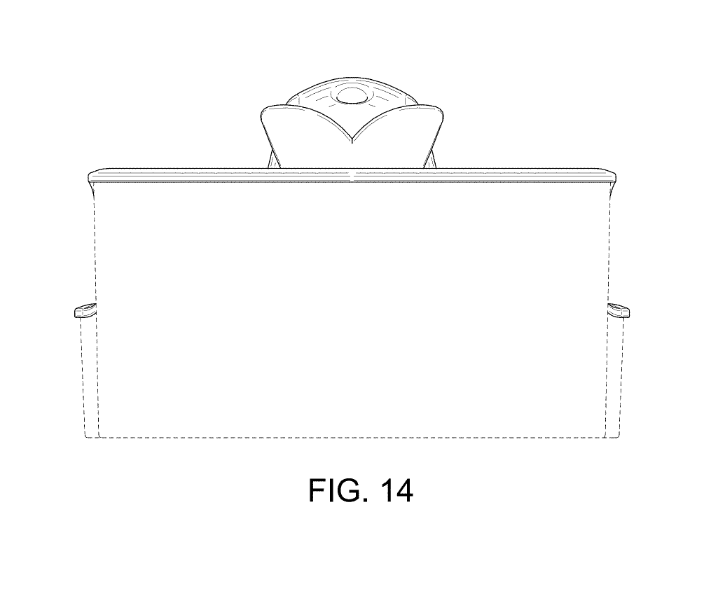

FIG. 15 is a right side view of one embodiment of the present invention.

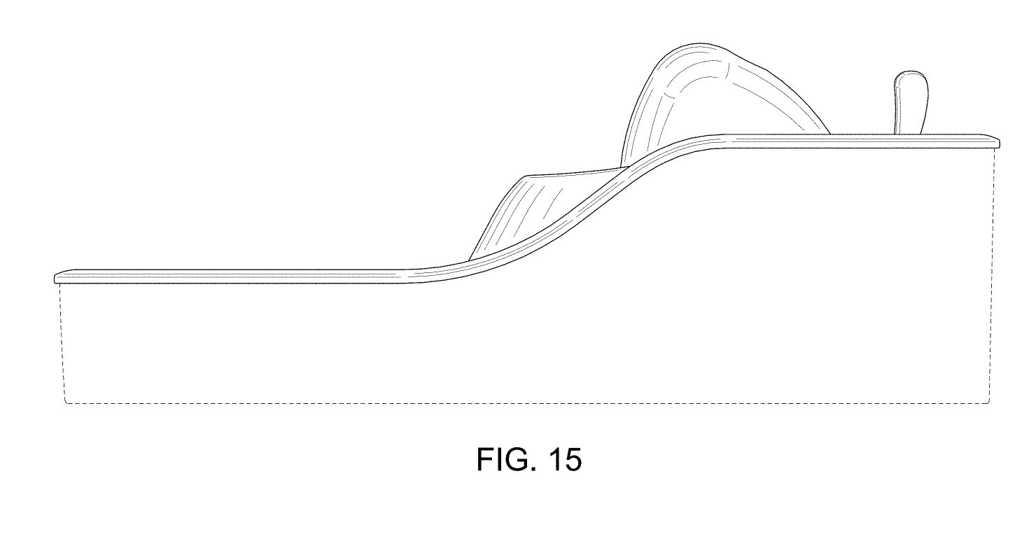

FIG. 16 is a left side view of one embodiment of the present invention.

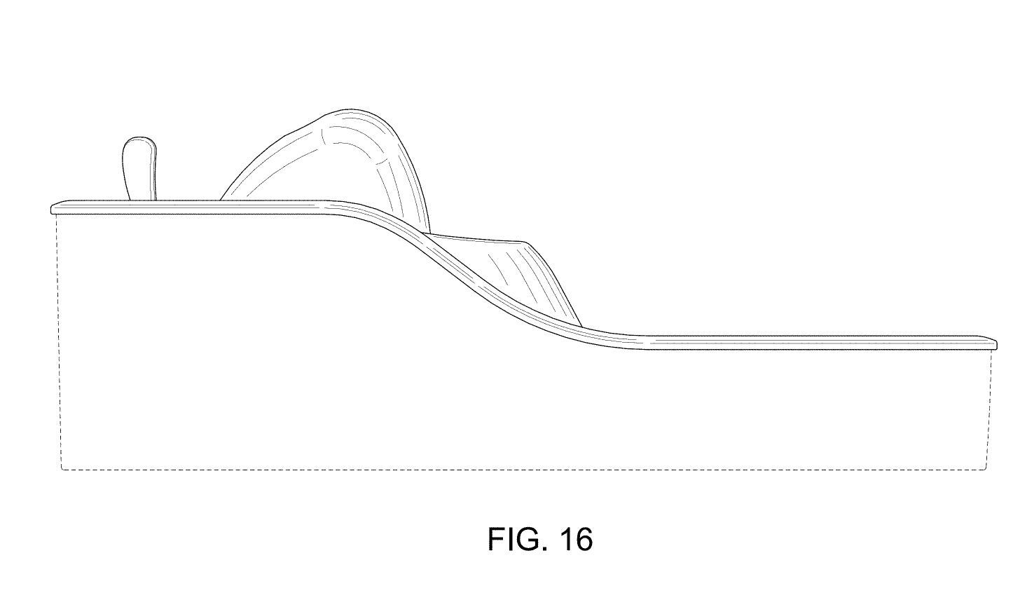

FIG. 17 is a top view of one embodiment of the present invention.

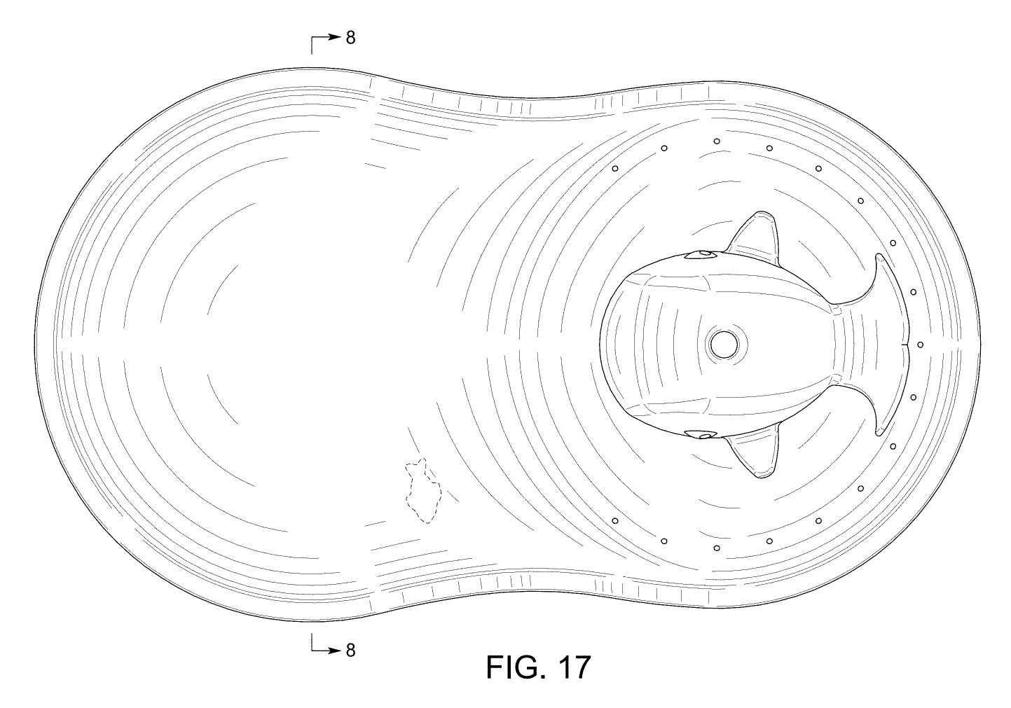

FIG. 18 is a bottom view of one embodiment of the present invention.

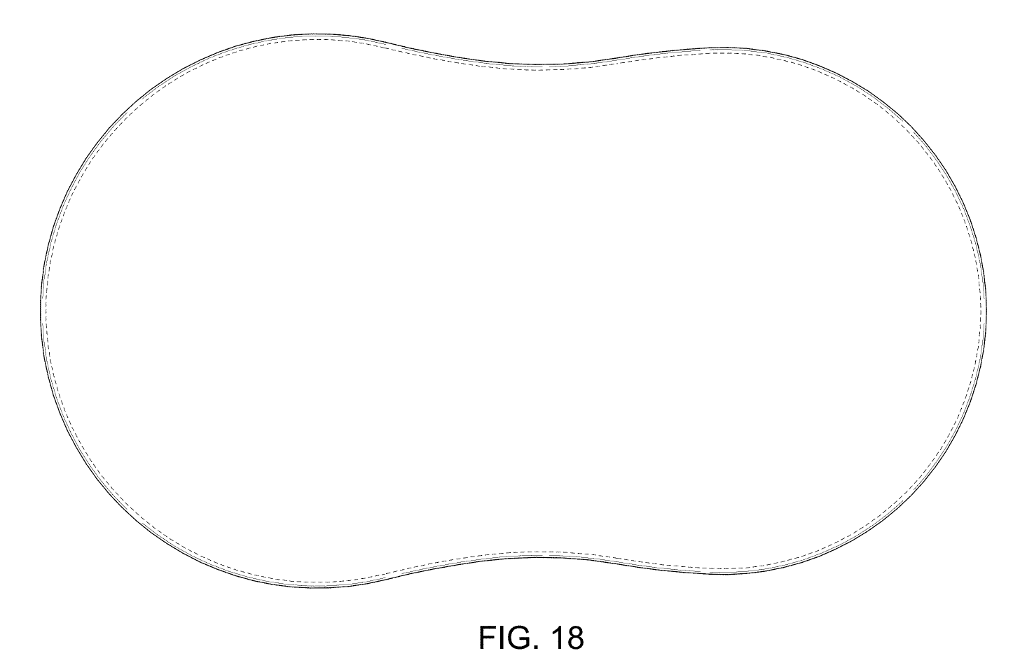

FIG. 19 is a cross-sectional view of a lower portion of one embodiment of the present invention.

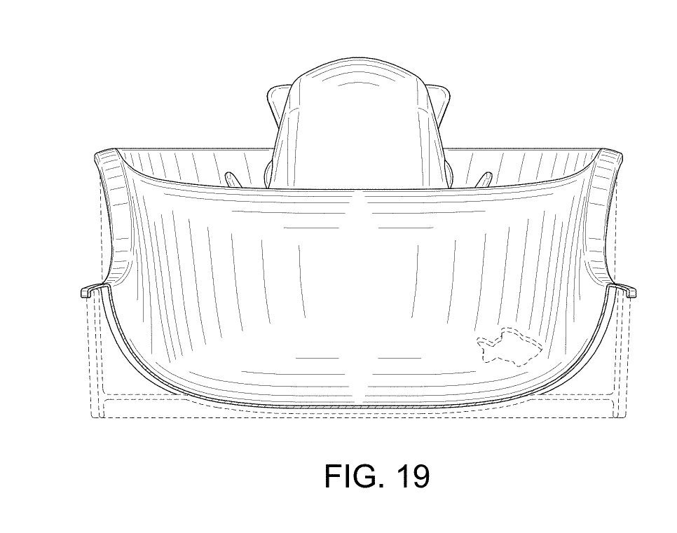

FIG. 20 is a front perspective view of one embodiment of the present invention.

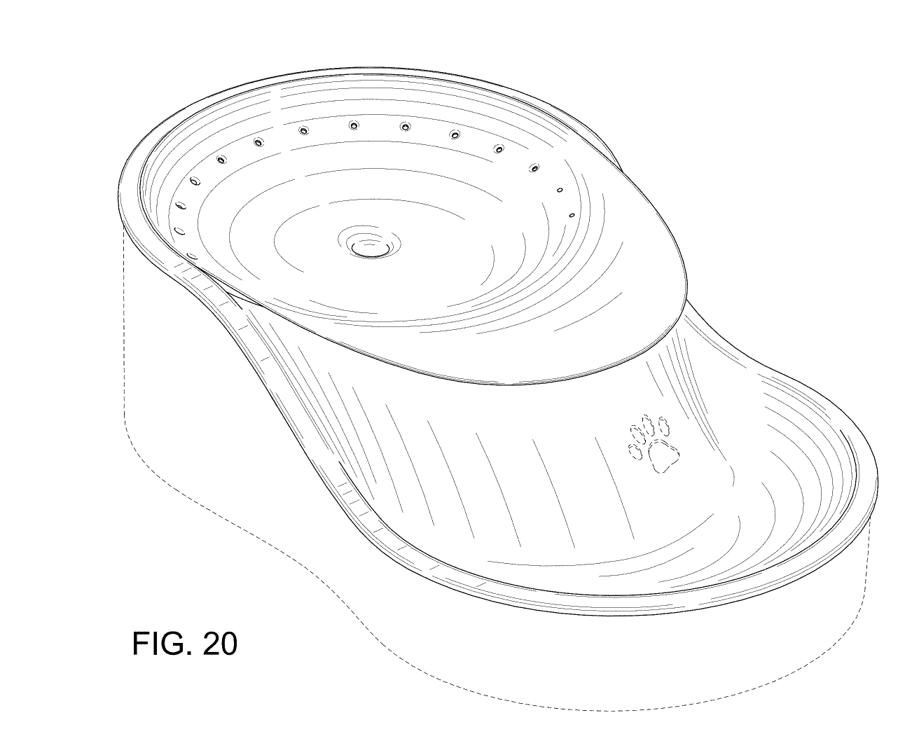

FIG. 21 is a front view of one embodiment of the present invention.

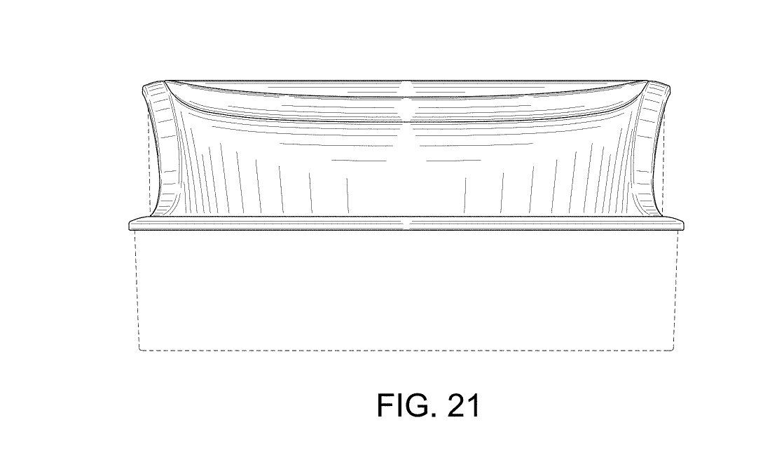

FIG. 22 is a back view of one embodiment of the present invention.

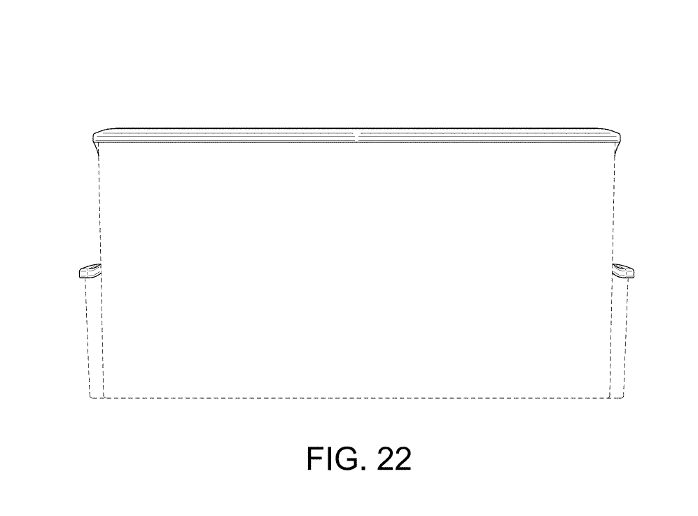

FIG. 23 is a right side view of one embodiment of the present invention.

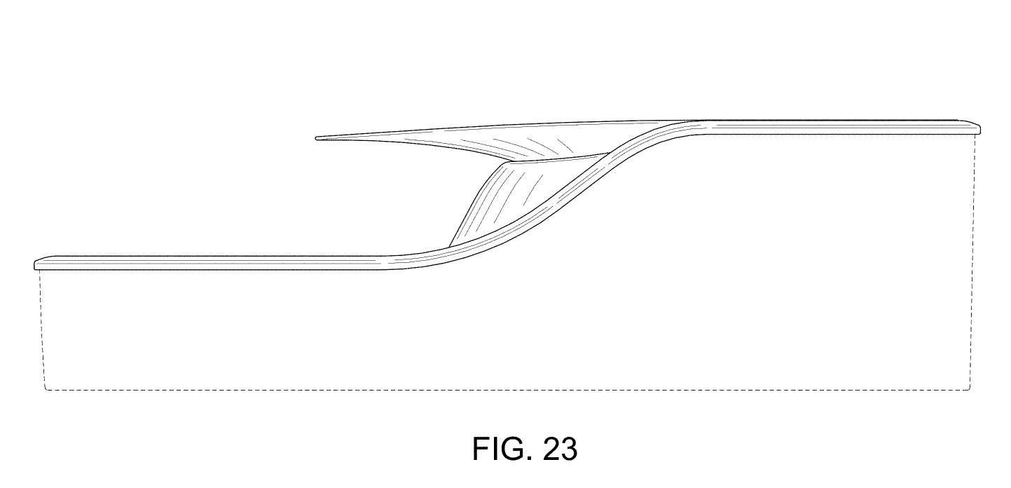

FIG. 24 is a left side view of one embodiment of the present invention.

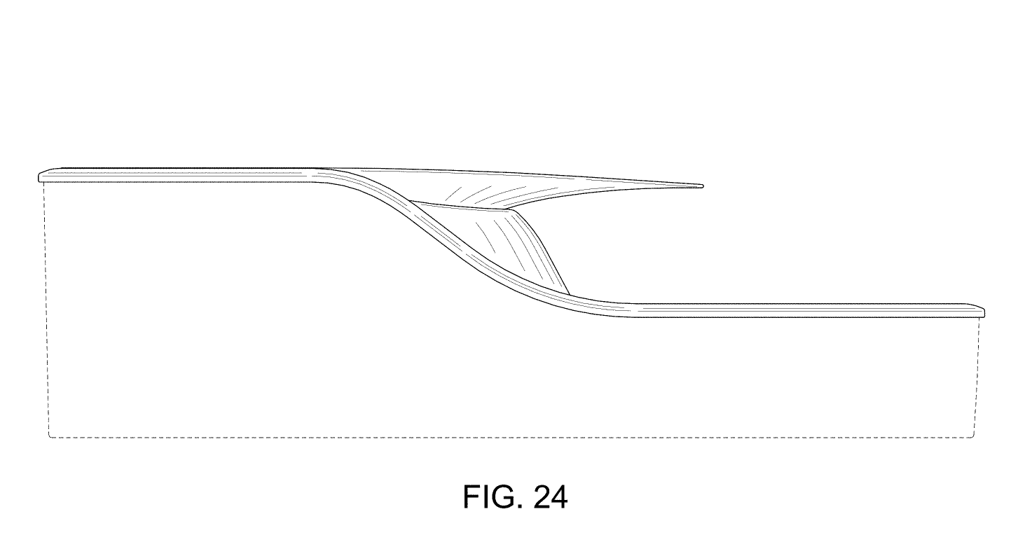

FIG. 25 is a top view of one embodiment of the present invention.

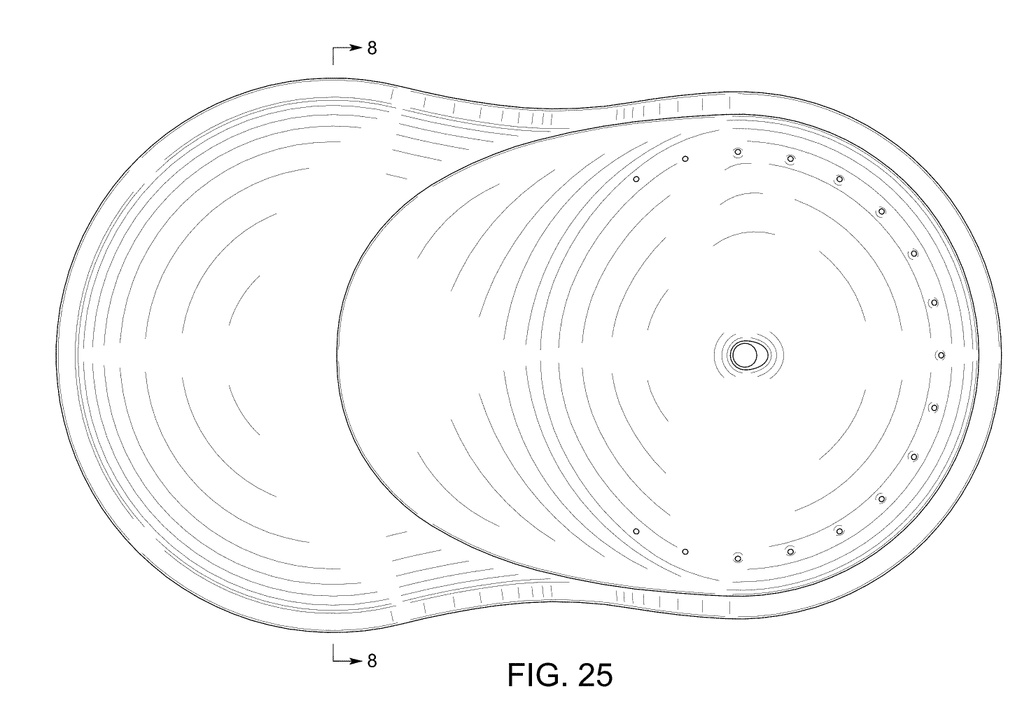

FIG. 26 is a bottom view of one embodiment of the present invention.

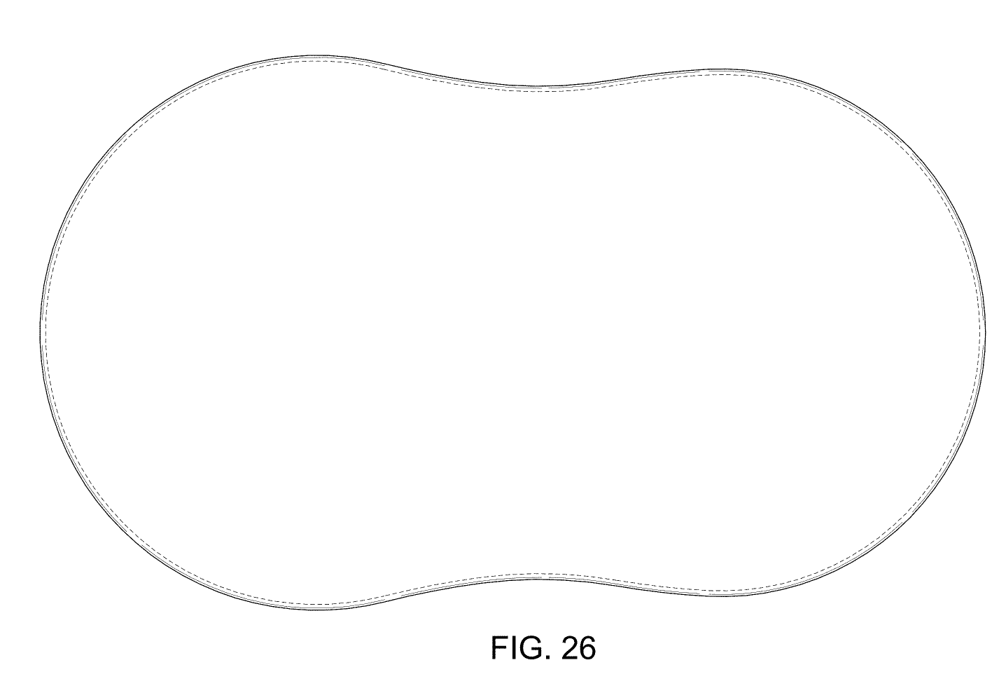

FIG. 27 is a cross-sectional view of a lower portion of one embodiment of the present invention.

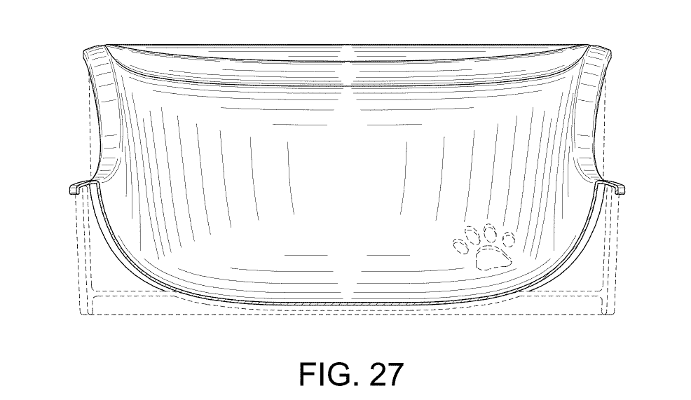

FIG. 28 is a front perspective view of one embodiment of the present invention.

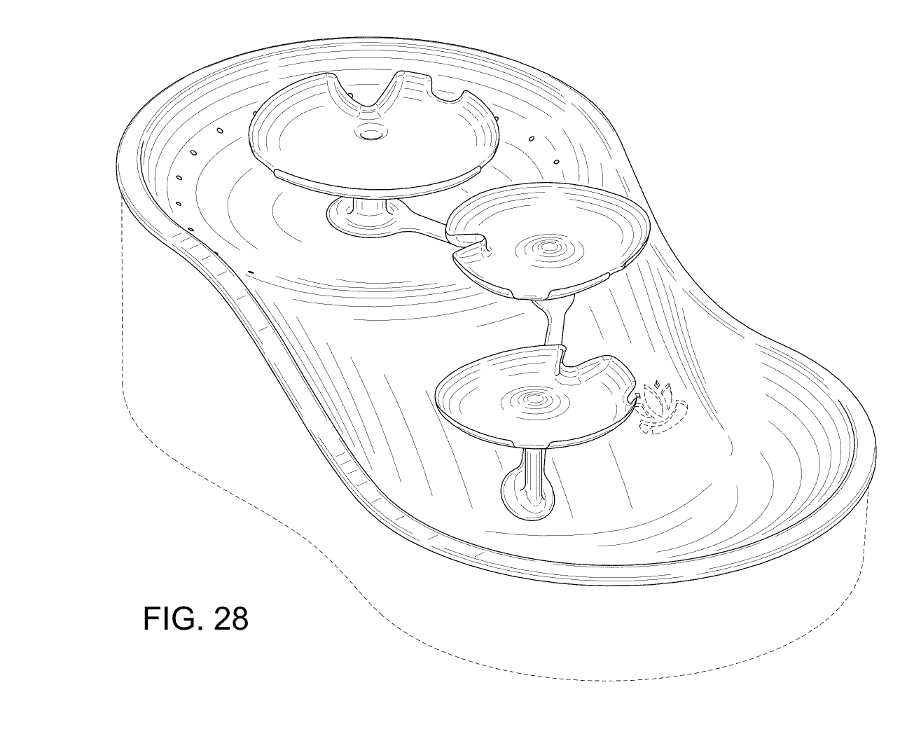

FIG. 29 is a front view of one embodiment of the present invention.

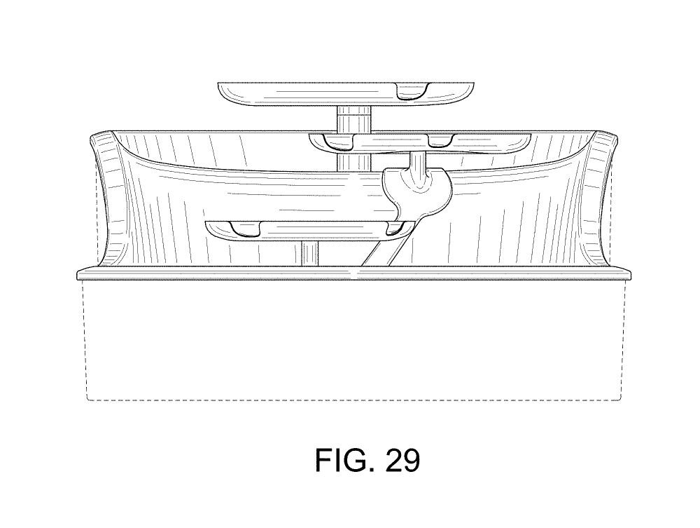

FIG. 30 is a back view of one embodiment of the present invention.

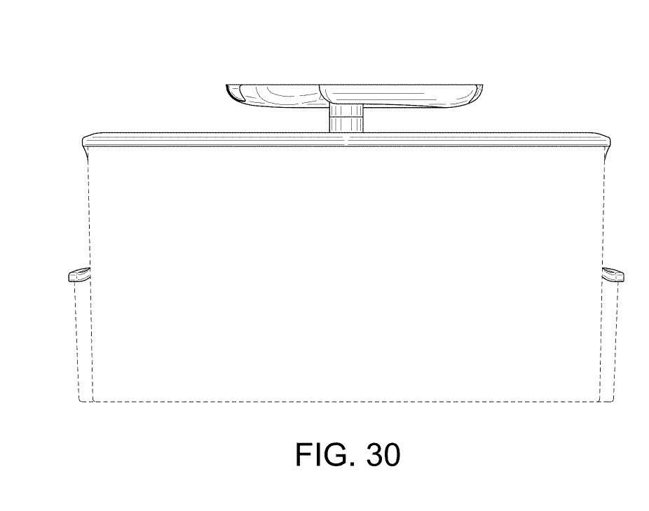

FIG. 31 is a right side view of one embodiment of the present invention.

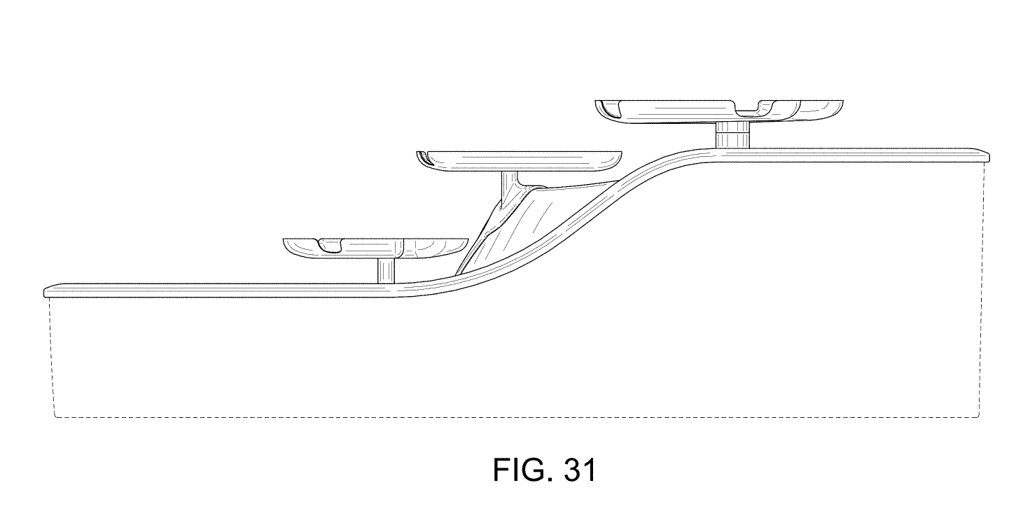

FIG. 32 is a left side view of one embodiment of the present invention.

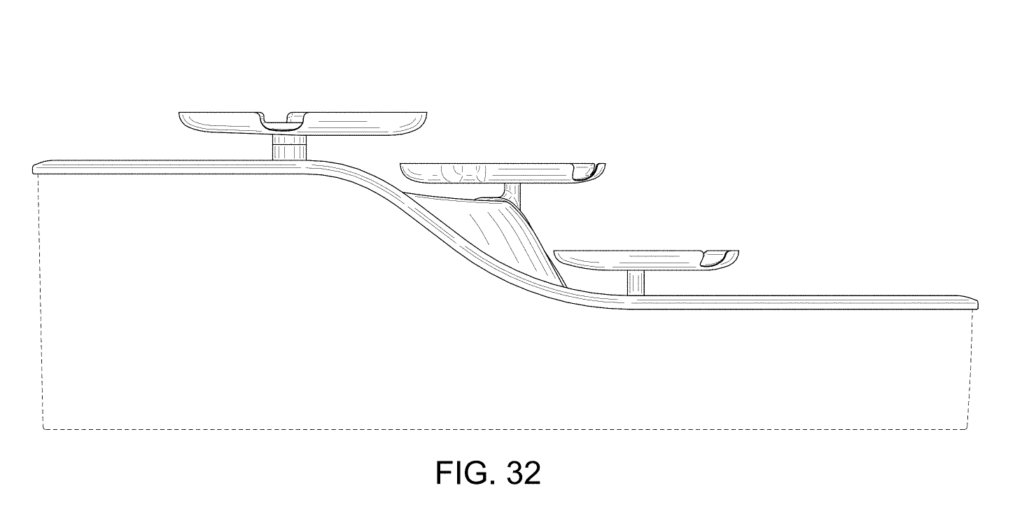

FIG. 33 is a top view of one embodiment of the present invention.

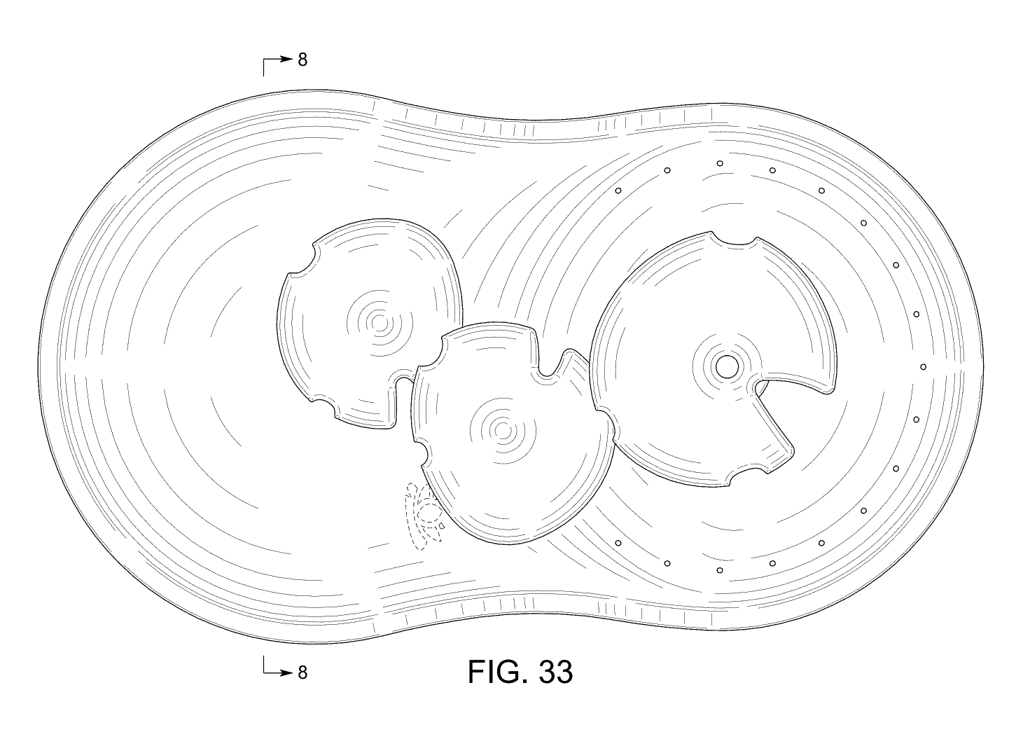

FIG. 34 is a bottom view of one embodiment of the present invention.

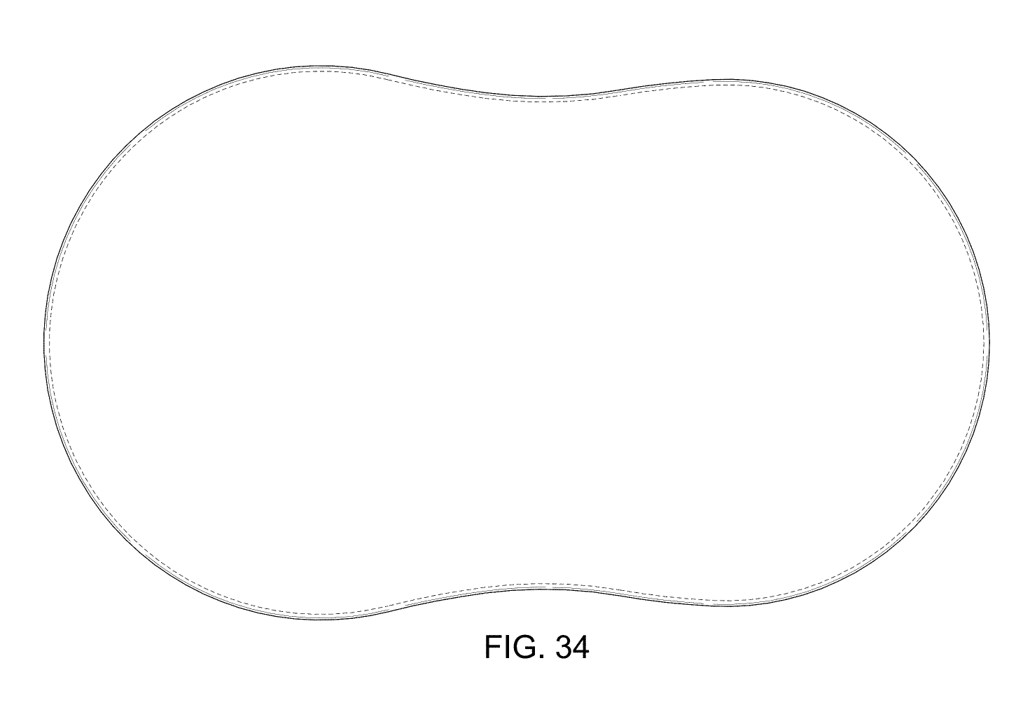

FIG. 35 is a cross sectional view of a lower portion of one embodiment of the present invention.

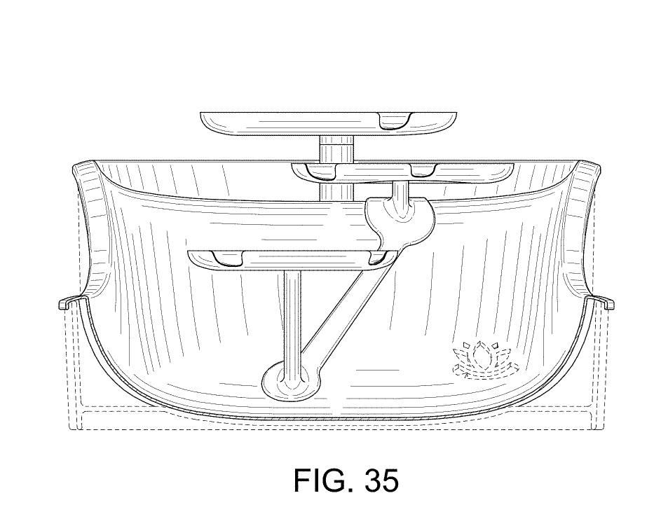

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

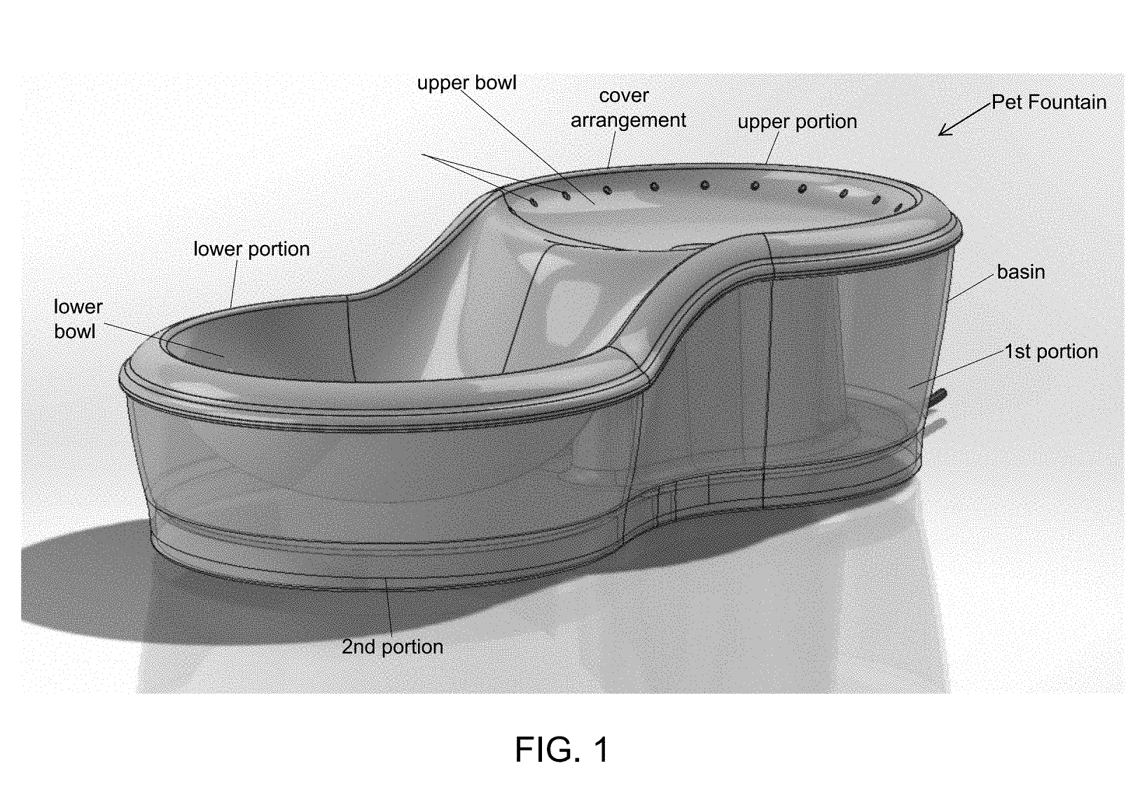

FIG. 1 is a schematic view of an example of top perspective view pet fountain according to a disclosed embodiment. The pet fountain includes a basin, a cover arrangement and a pump. FIG. 1 shows a clear basin in one embodiment of the invention. Clear components of the pet fountain can aid pet owners in identifying the purity level of the water in the pet fountain at a glance.

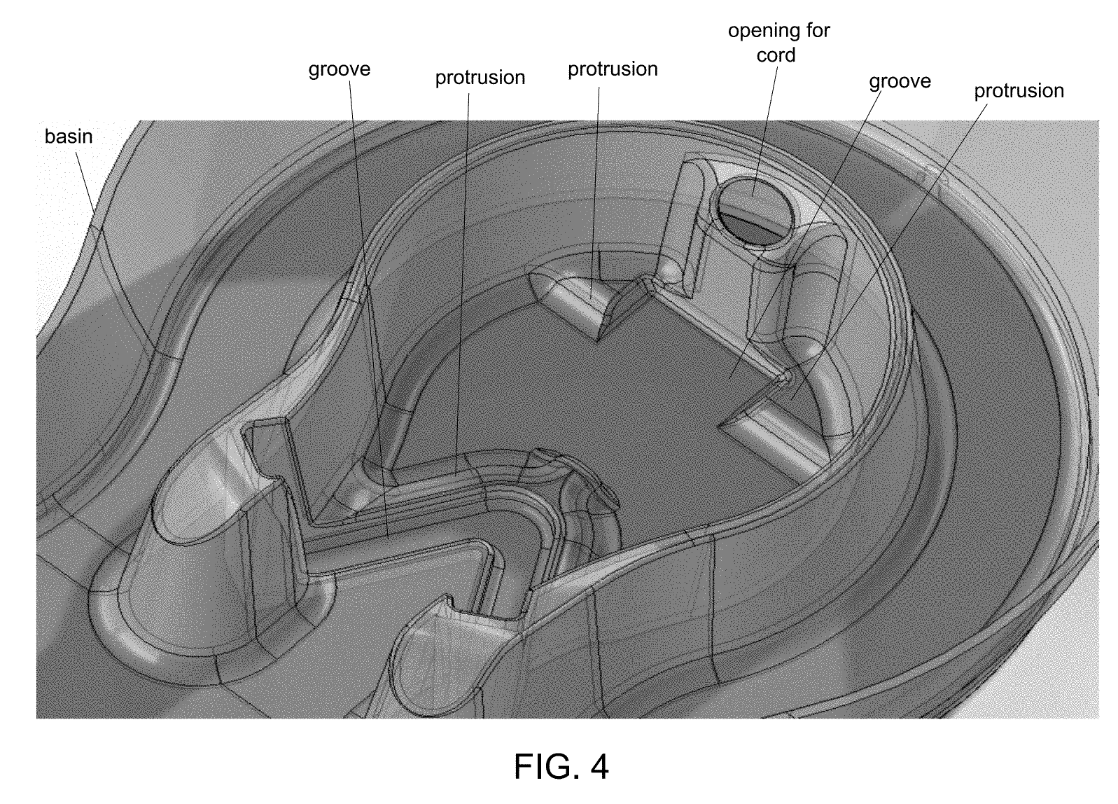

The basin is a plastic molded basin that a first portion and a second portion. The first portion is generally circular and has a first height. The second portion is also generally circular and has a second height that is less than the first height. The first portion is configured to receive the upper bowl and the second portion is configured to receive the lower bowl. The first portion is also configured to receive the pump and the filter. As shown in FIGS. 4-6 the second portion includes grooves and protrusions that enable the pump and the filter to be captively and securely held within the basin. Preferably all interior surfaces have a minimum of 5 mm convex fillets and 1 mm concave fillets, but can be any dimensions desired.

The outer walls of the first and second portion can be transparent or translucent to enable the water in the basin and falling from the cover arrangement to be seen therethrough. The interior walls of the basin can have a 5 degree draft to allow for very aggressive textures.

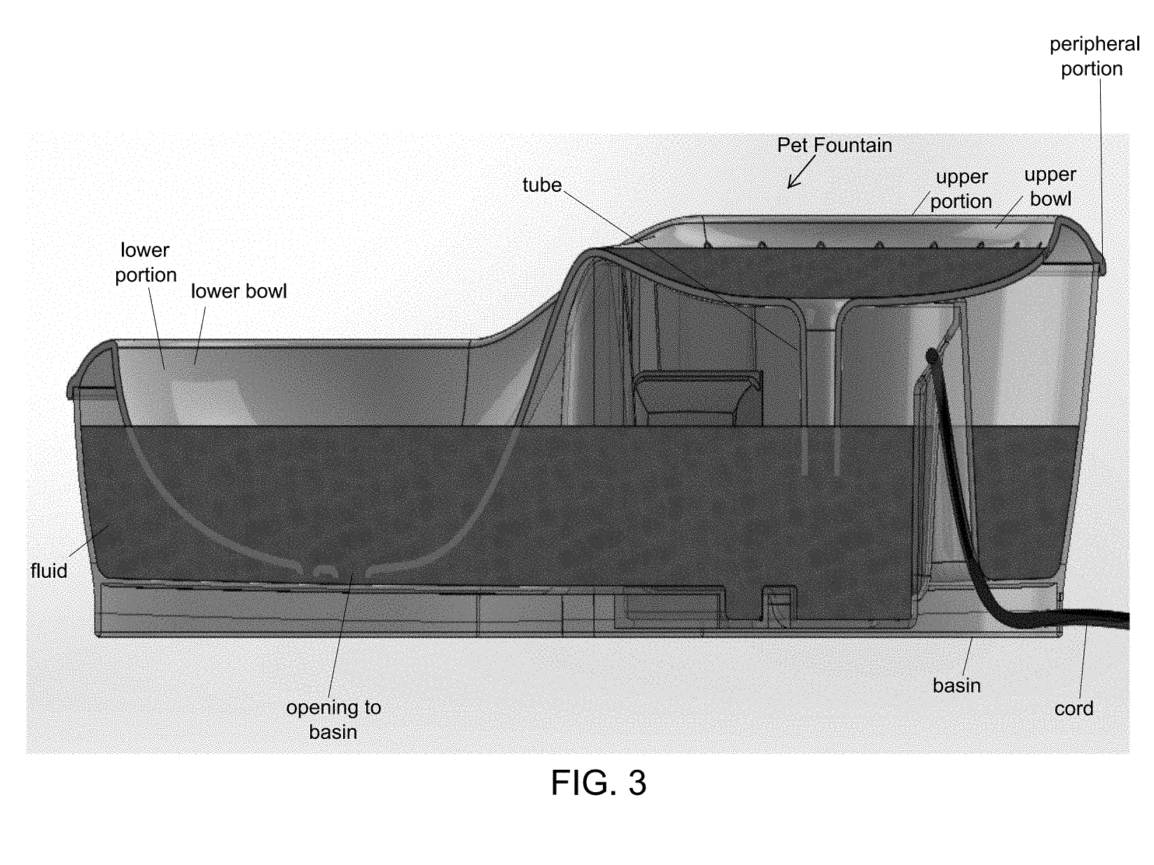

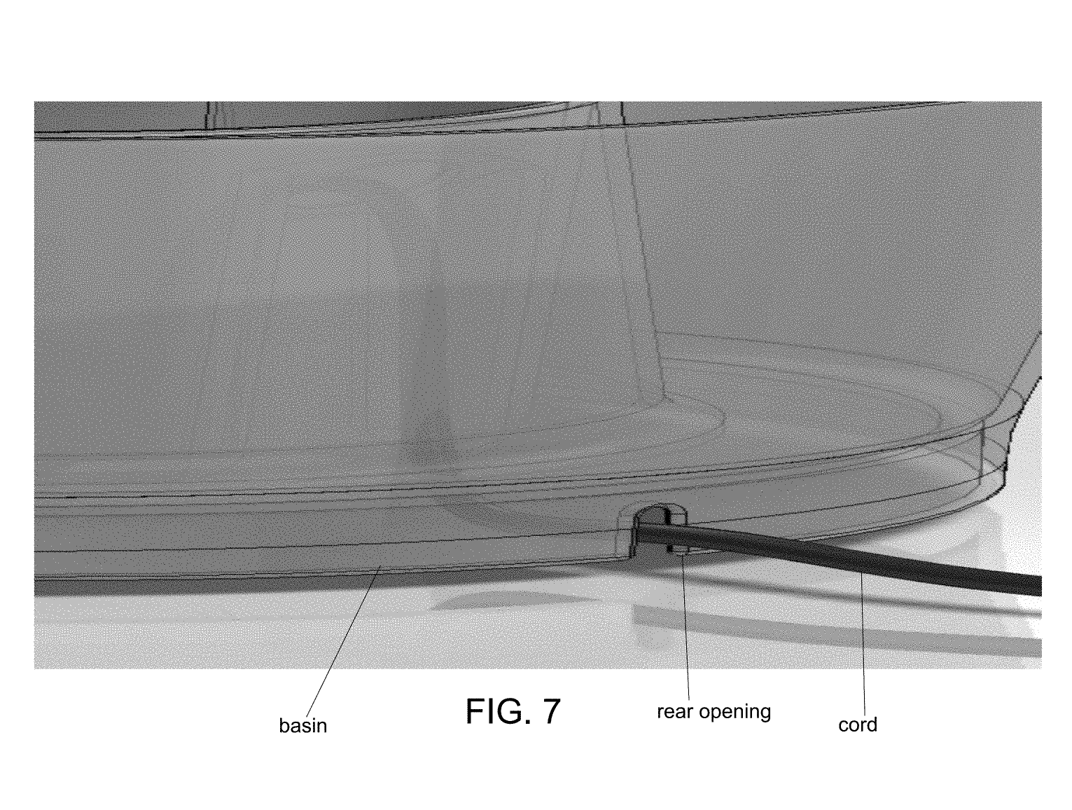

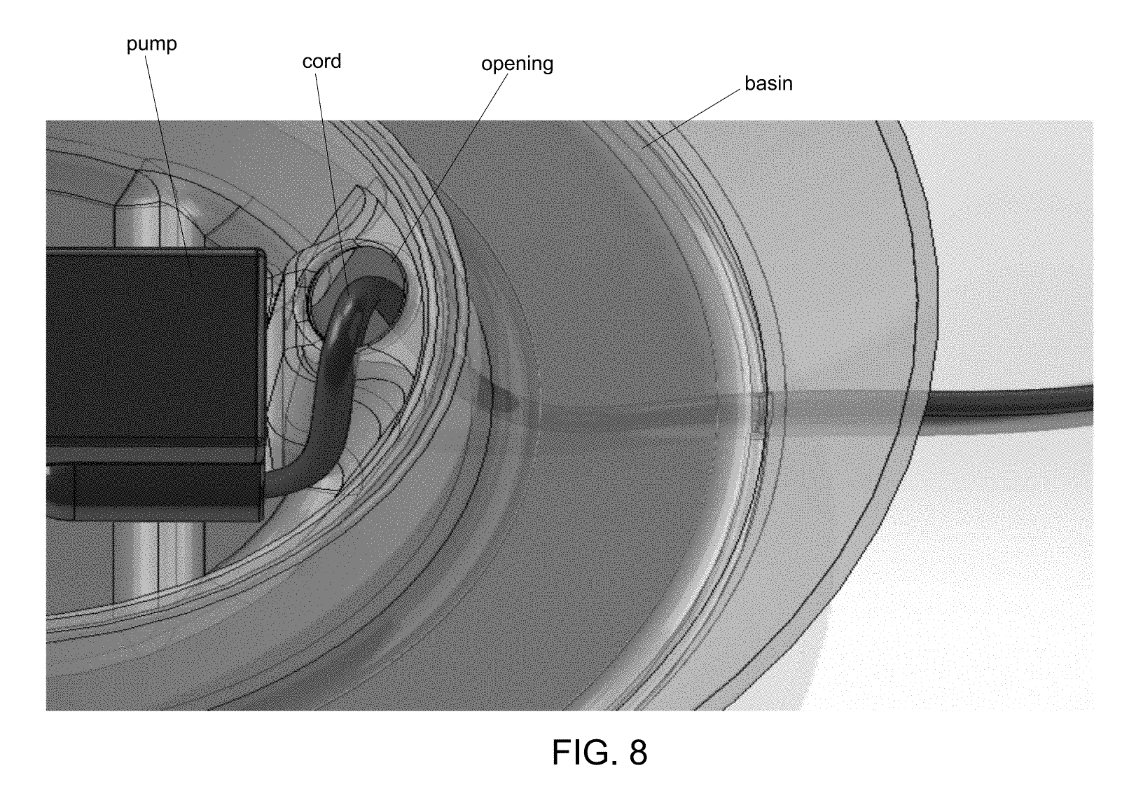

Additionally, as shown in FIGS. 3-5 and 8, the second portion includes an opening to enable the power cord of the pump to extend therethrough and to the exterior of the pet fountain. Preferably, the opening is disposed above the water fill line so that when in used water does not exit the opening. See for example, FIG. 3. This opening is preferably 15 mm (slightly larger than plug socket), while the opening in FIG. 7 at the rear exit preferably has slightly smaller diameter than the cord so that the cord can be hugged in place.

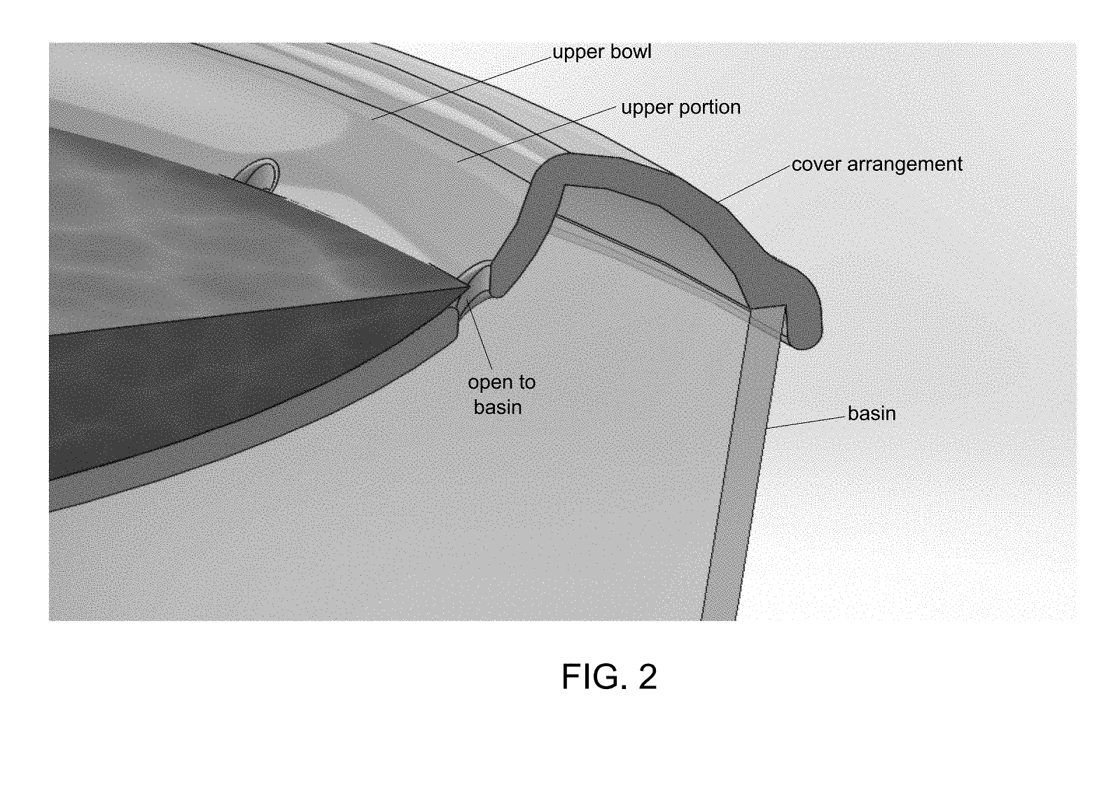

The cover arrangement is preferably a molded plastic member and can be disposed over the basin. The cover arrangement includes an upper portion, a lower portion and an inclined portion connecting the upper portion and the lower portion. The peripheral portion of the cover arrangement attaches to the edges of the walls of the basin. In open embodiment, the peripheral portion of the cover arrangement snap fits to the basin. See for example, FIGS. 2 and 3. The top portion of the includes wall can be supported by a wall of the basin separating the first portion and the second portion.

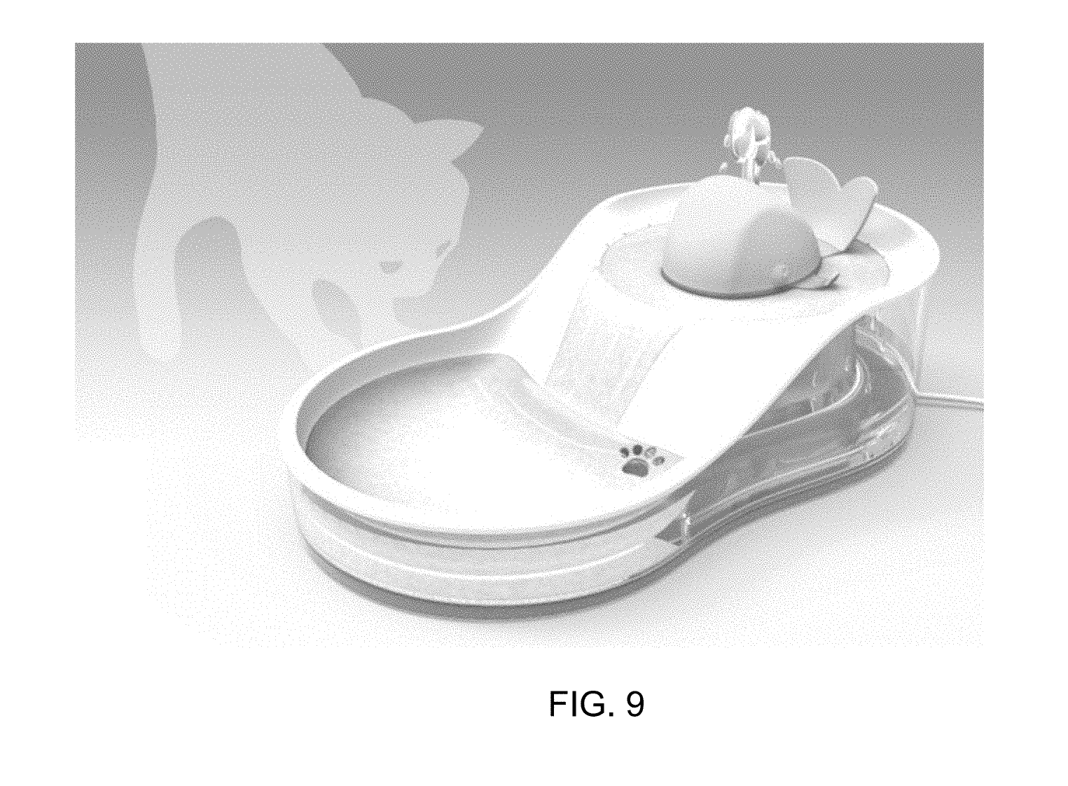

The lower portion includes a lower bowl that can hold water or any fluid to enable a pet to drink therefrom. As shown in FIG. 3, the bowl in the lower portion can include an opening or a plurality of openings to enable the fluid to pass from the bowl in the lower portion into the basin. The opening or plurality of openings can be anywhere in the bowl in the lower portion. As shown in FIGS. 9, 10, and 11, the opening or plurality of openings can be in the form of a design such as a pawprint, a fish outline, or a flower outline.

The upper portion includes an upper bowl that can hold water or any fluid to enable a pet to drink therefrom. The bowl in the upper portion can be shallower that the bowl in the lower portion. The bowl in the upper portion includes openings therein that enable the fluid to pass through the upper portion and into the basin. Preferably the fluid falls from the upper portion into the basin to create a waterfall effect. The bowl in the upper portion can also include a tube that connects to a pump output.

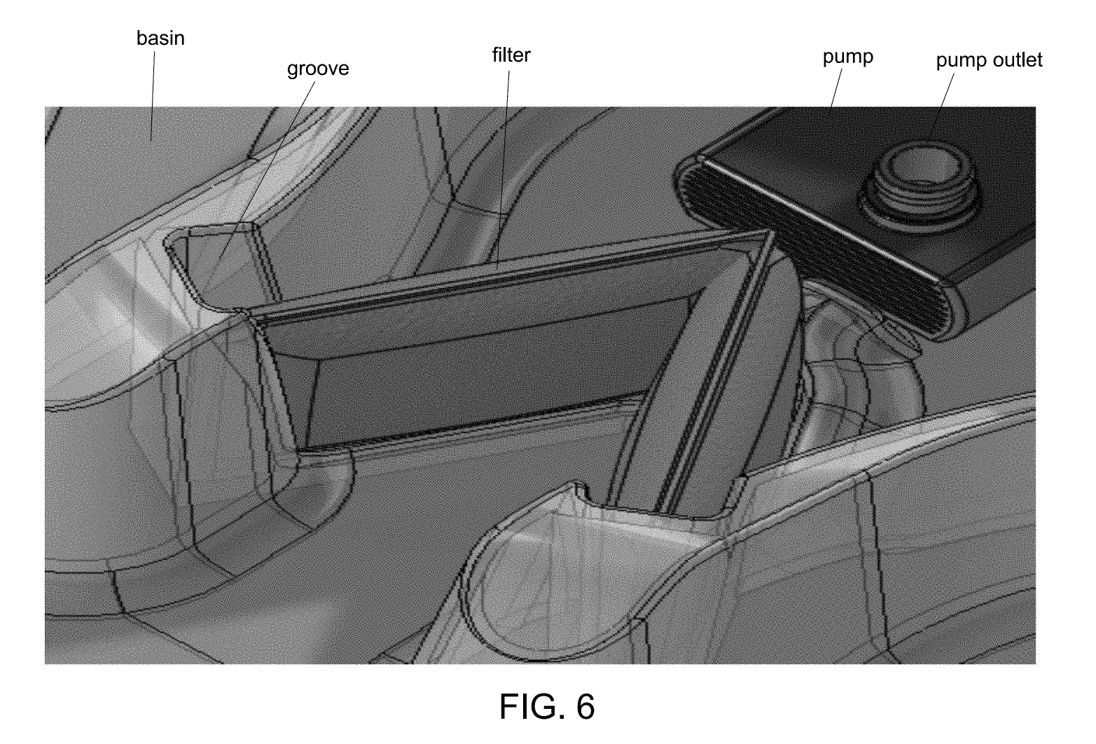

The pump can be any suitable pump and is generally a submersible pump. As shown in FIG. 6, the pump can have an intake disposed adjacent the filter with an output that is connected to the tube in the bowl of the upper portion. As described herein, the pump power cord can then exit the opening in the basin. The pump and the filter can be hidden behind three opaque plastic walls within the center portion of the basin. As illustrated in FIG. 3, the basin can have raised reservoir floor that allows for a maximum amount of water to get to the pump “Grotto”. The floor is curved slightly at the extremes so that the water is directed to the “Grotto” channel.

To assemble the pet fountain, the pump and the filter are positioned within the appropriate grooves and protrusions. As shown in FIG. 4, two points or protrusions enable base positioning to allow the pump to be securely placed in the right position without the lid on. The cradled positioners were designed with a tolerance to accommodate the suction cup placements of the pump. With this positioning, the tube of the upper bowl can be lined up with the pump tube outlet. As shown in FIG. 6, when the filter is positioned with the grooves and protrusions, the seam between the two filters is blocked with the filter, to ensure all water passes through the activated charcoal. The filters can be positioned at a different location based on the specific design of the fountain. As shown in FIGS. 9, 10, and 11, an opening or plurality of openings in the lower bowl can be in the form of a design such as a pawprint, a fish outline, or a flower outline. At least in one embodiment of the invention, a filter or filters can be included at that position of the invention.

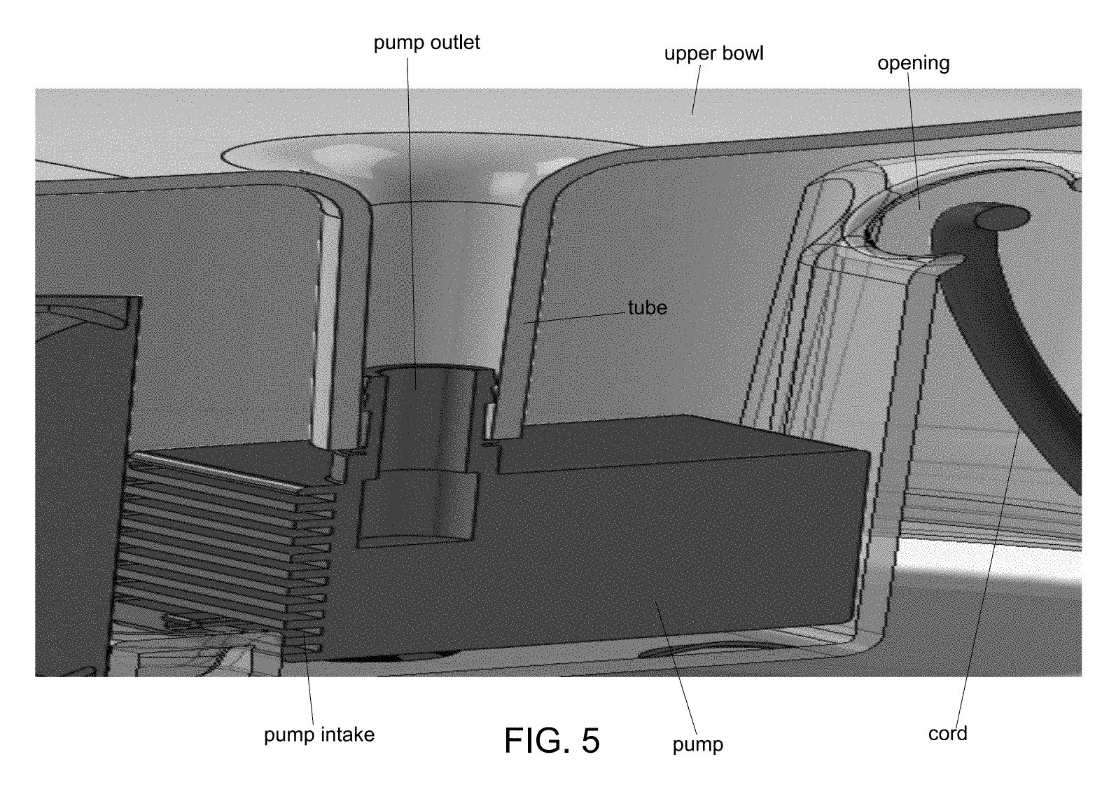

The pump cord passes through the opening in the basin and out of another opening in the bottom of the basin. See for example FIGS. 3, 5, 7 and 8. The cover arrangement is then positioned over the basin with the upper portion disposed over the first portion and the lower portion disposed over the second portion. The tube of the upper bowl fits onto the pump tube outlet as shown in FIG. 5.

Prior to or after positioning of the cover arrangement water can be added to the pet fountain. The pump can then be activated. The pump can pump fluid up through the tube and into the upper bowl. The water in the upper bowl will pass through the openings in the upper bowl and fall back into the basin. Moreover, as the upper bowl fills water will overflow from the upper bowl and pass over the inclined portion and into the lower bowl. The water can also fill in the lower bowl from the basin through the openings in the lower bowl.

FIG. 9 illustrates another embodiment in which a whale is disposed in the upper bowl. In this embodiment, water passes from the tube in the upper bowl through the whale and into the upper bowl.

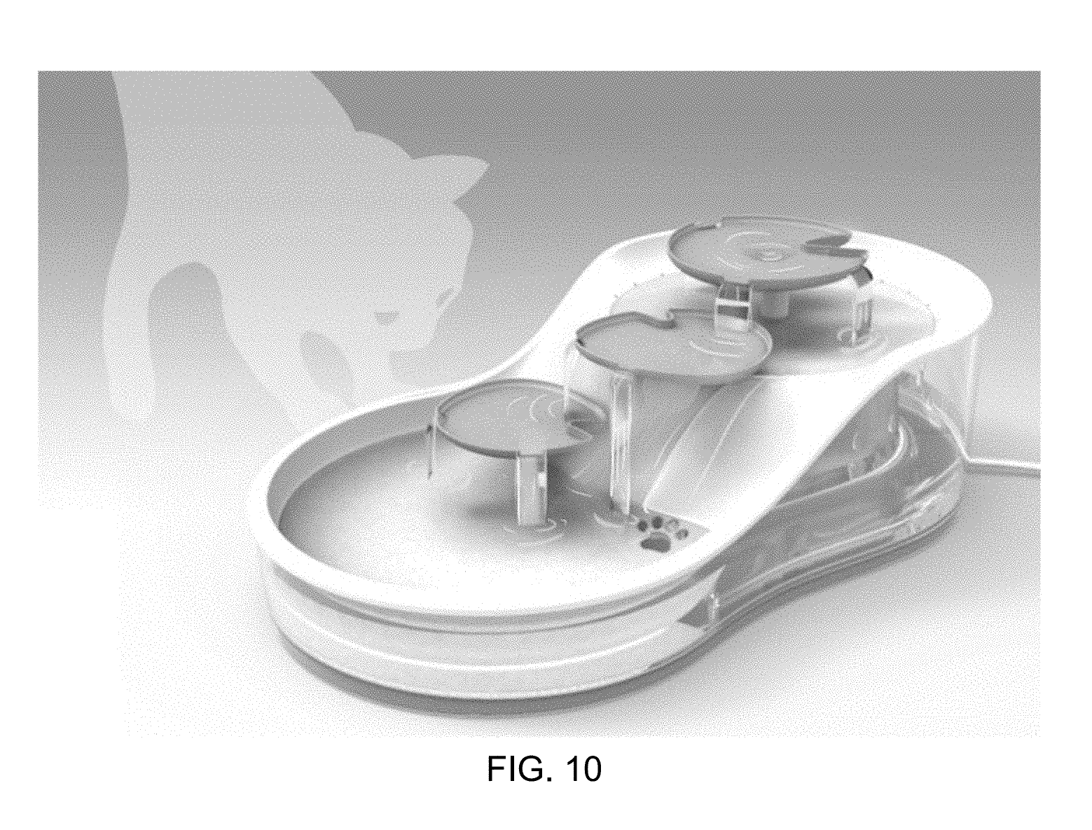

FIG. 10 illustrates another embodiment in which a plurality of lily pads is disposed in the upper bowl, on the inclined surface and/or in the lower bowl. In this embodiment, water passes from the tube in the upper bowl through the upper lily pad which cascades into the upper bowl and/or through the series of lily pads and into the lower bowl.

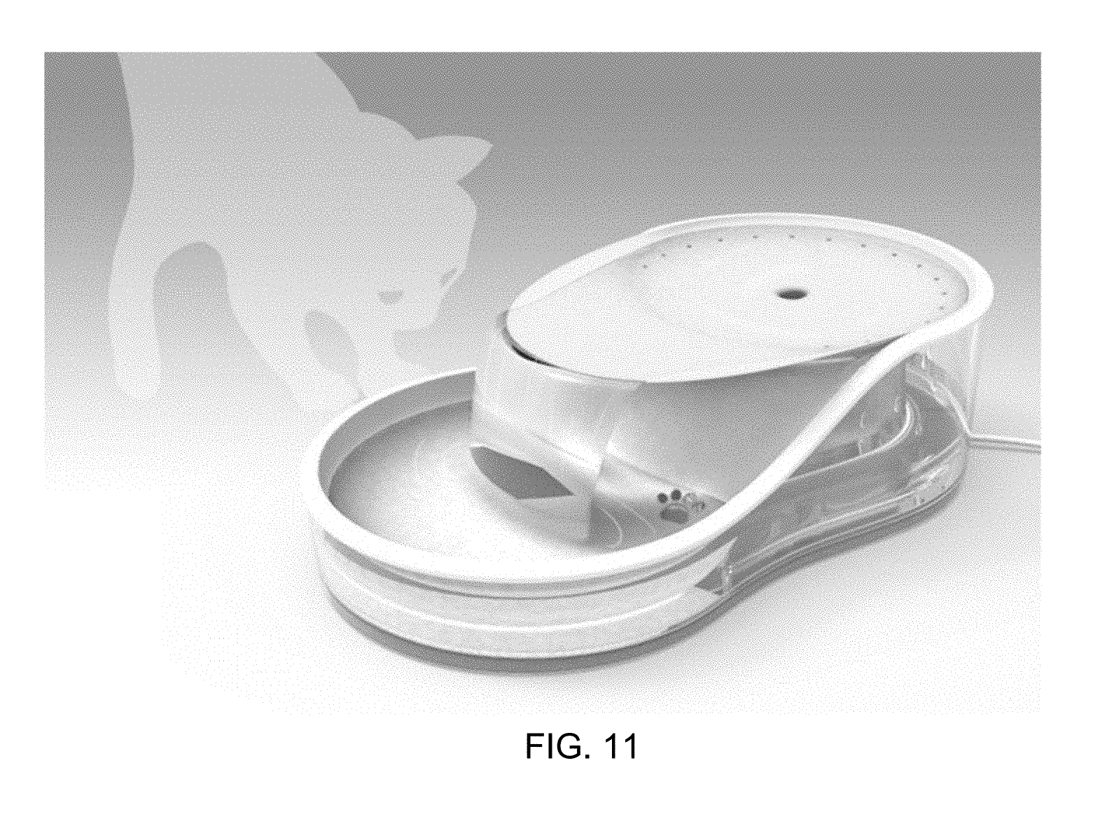

FIG. 11 illustrates another embodiment in which a ledge is disposed on the upper bowl. The ledge can extend outwardly from the upper bowl and overhang the lower bowl in this embodiment, water passes from the tube in the upper bowl into the upper bowl and then cascades over the ledge into the lower bowl to create a waterfall effect.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet fountain, comprising:
a basin;
a cover arrangement disposed over the basin, and including an upper bowl, a lower bowl and an inclined portion connecting the upper bowl and the lower bowl, the upper bowl including openings disposed to enable water to fall from the upper bowl into the lower basin, and enabling water to flow from the upper bowl along the inclined portion to the lower bowl; and
a pump disposed in the basin and configured to pump water from the basin to the upper bowl.
